(19) United States
(12) Patent Application Publication
(10) Pub. No.: US 2020/0367477 A1
(43) Pub. Date: Nov. 26, 2020

(54) ARTIFICIAL CORAL ARTICLES AND PREPARATION METHODS THEREOF

(71) Applicant: Alexander SCHOFIELD, Oakland, CA (US)

(72) Inventor: Alexander SCHOFIELD, Oakland, CA (US)

(21) Appl. No.: 16/422,859

(22) Filed: May 24, 2019

(51) Int. Cl. A01K 61/70; C09J 101/02; B29C 64/165; C09J 101/08; C09J 103/04

(52) U.S. Cl. CPC A01K 61/70; C09J 101/02; B33Y 10/00; C09J 101/08; C09J 103/04; B29C 64/165

(57) ABSTRACT

Disclosed in this application are embodiments related to artificial coral articles, preparation methods thereof, and methods for introducing the artificial coral articles to coral reef polyps and fragments. Also disclosed in this application are embodiments related to compositions used for preparation of the artificial coral articles and methods for screening the compositions.

### TECHNICAL FIELD

The field of the invention is artificial coral.

### BACKGROUND

Coral provide food, shelter, protection, and spawning areas for hundreds of species of fish and other marine organisms. However, natural coral once damaged may take a long time to recover. Thus, there is a need for providing artificial coral articles to be inhabited by coral reef ecosystems.

### SUMMARY

One aspect of the disclosed embodiments related to a method for introducing an artificial coral article to coral reef polyps and fragments.

Another aspect of the disclosed embodiments related to methods for preparing artificial coral articles using a three-dimensional (3D) printer, a powder composition, a binder composition, and optionally one or more post-processing agents.

Another aspect of the disclosed embodiments related to artificial coral articles and intermediate articles thereof prepared by the methods disclosed herein.

Another aspect of the disclosed embodiments related to the powder compositions and/or the binder composition used for preparing artificial coral articles as disclosed herein.

Another aspect of the disclosed embodiments related to a method for screening a powder composition and/or a binder composition for uses in preparing an artificial coral article as disclosed herein.

### BRIEF DESCRIPTION OF DRAWINGS

FIG. 1 shows a flowchart of a method for preparing an artificial coral article according to an embodiment disclosed herein.

FIG. 2 shows a flowchart of a printing step according to an embodiment disclosed herein.

FIG. 3(A)-3(D) show pictures of artificial coral articles prepared according to embodiments disclosed herein.

### DETAILED DESCRIPTION

### I. Methods for Introducing of Artificial Coral Article(s) Disclosed Herein

One aspect of the disclosed embodiments related to a method for introducing an artificial coral article to coral reef polyps and/or fragments. In certain embodiments, the introducing step is through means of asexual reproduction, budding, cloning, and/or fragmentation.

In certain embodiments, the introduction of the artificial coral article to coral reef polyps and/or fragments comprises I) introducing the artificial coral article to the coral reef polyps and/or fragments in a first wild environment (e.g., the field) to provide a first artificial coral article combination; and II) introducing the first artificial coral article combination to coral reef polyps and/or fragments in a second wild environment, wherein the first and the second wild environments may be the same or different.

In certain embodiments, the introduction of the artificial coral article to coral reef polyps and/or fragments comprises I) introducing the artificial coral article to the coral reef polyps and/or fragments in a controlled condition (e.g., a lab condition) to provide a first artificial coral article combination; and II) introducing the first artificial coral article combination to coral reef polyps and/or fragments in a second wild environment.

### II. Artificial Coral Articles and Intermediate Articles

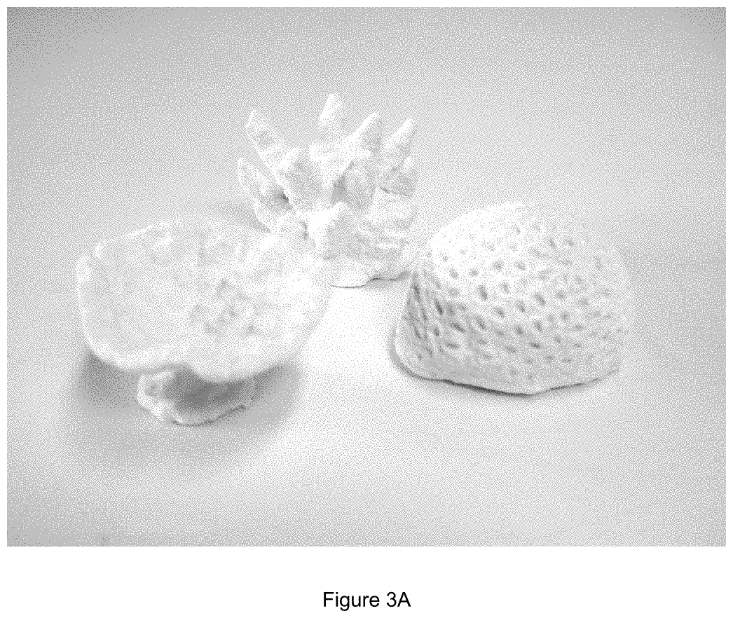

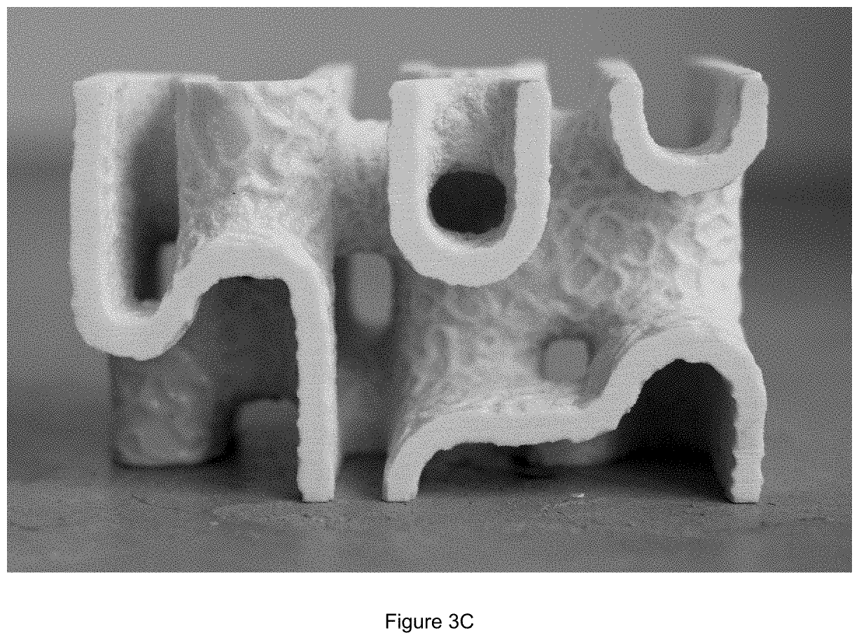

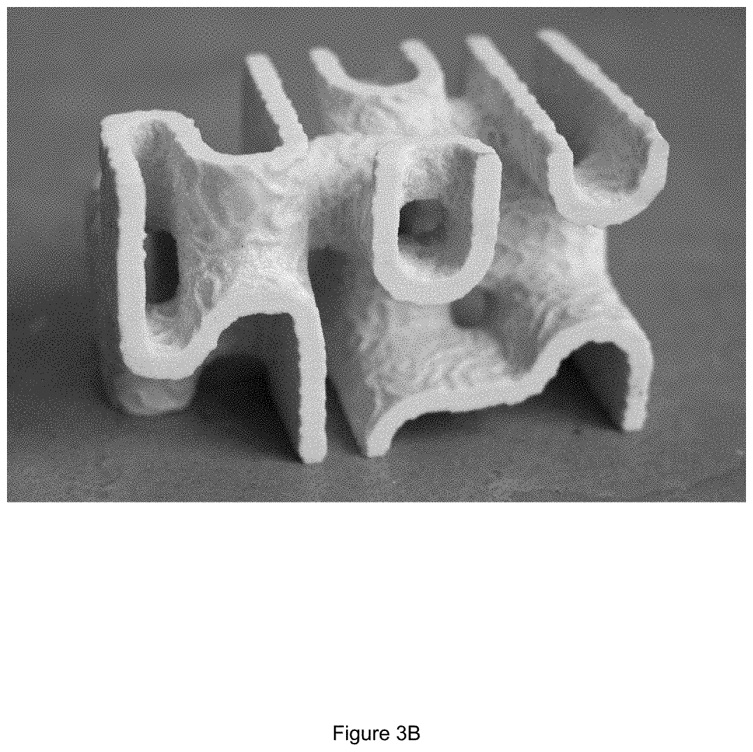

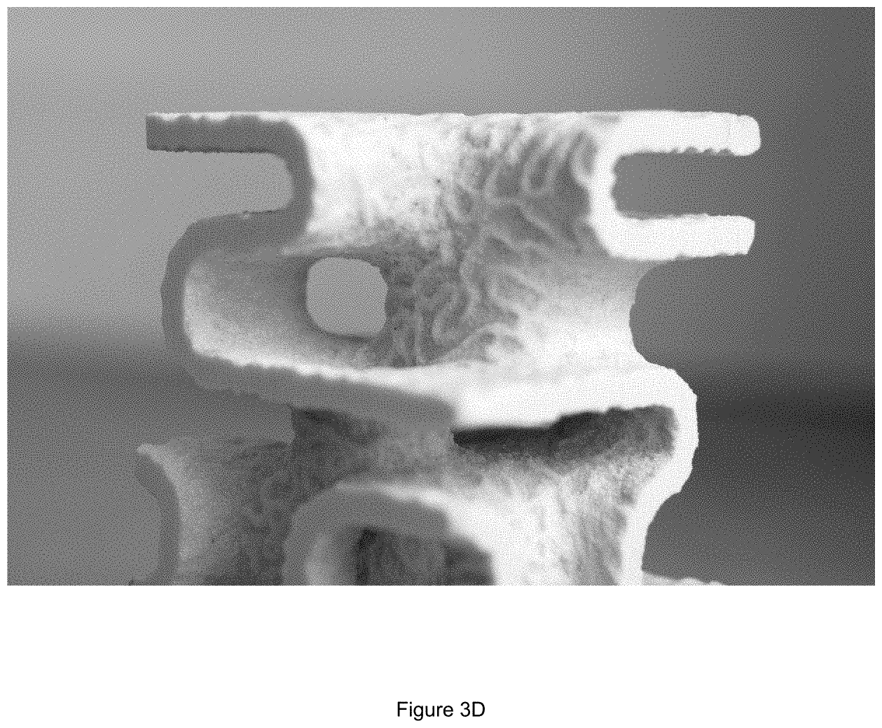

Another aspect of the disclosed embodiments related to an artificial coral article and/or intermediate article prepared by a method disclosed herein. Pictures of example artificial coral articles are shown in FIGS. 3A-3D.

As used herein the term “intermediate article” means an article prepared by a method disclosed herein that are not post-processed.

### III. Preparation Method for Artificial Coral Articles

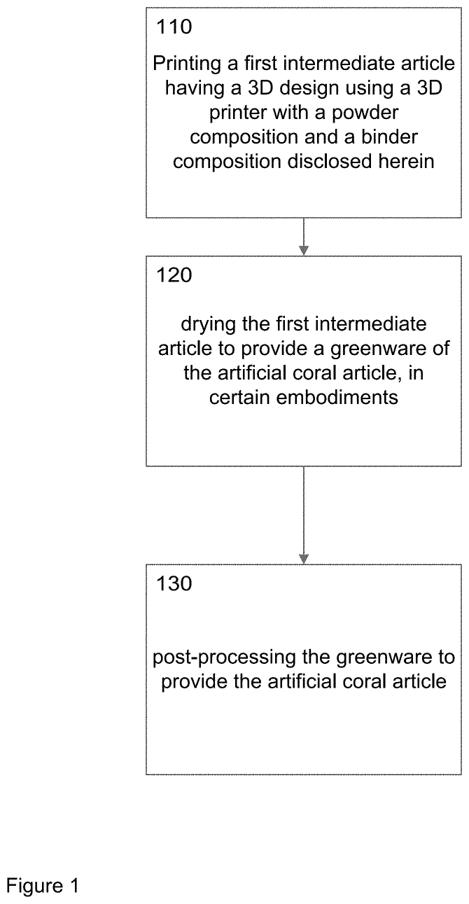

Another aspect of the disclosed embodiments related to a method for preparing an artificial coral article comprising:
A) printing a first intermediate article having a 3D design using a 3D printer with a powder composition and a binder composition disclosed herein (Operation 110, FIG. 1);
B) drying the first intermediate article to provide a greenware of the artificial coral article (Operation 120, FIG. 1), in certain embodiments, the drying step takes at least about 3 to about 72 hours, about 3 to about 48 hours, about 3 to about 24 hours, or at least about 5 to about 18 hours, in certain embodiments, the drying step provides a greenware with sufficient mechanical to retain its form; and
C) post-processing the greenware to provide the artificial coral article (Operation 130, FIG. 1).

In certain embodiments, the post-processing step would not alter the 3D configuration of the first intermediate article, and therefore, the first intermediate article and the artificial coral article have an identical 3D design. In certain embodiments, the post-processing step may alter the 3D configuration of the first intermediate article, and therefore, the first intermediate article and the artificial coral article may have different 3D designs.

Optionally, the preparation method further comprises excavating the greenware of step B). Optionally, the preparation method further comprises collecting the powder composition that is not incorporated in the artificial coral article or intermediate article (i.e., the unused powder composition). Optionally, the preparation method further comprising using the collected unused powder composition in the printing step.

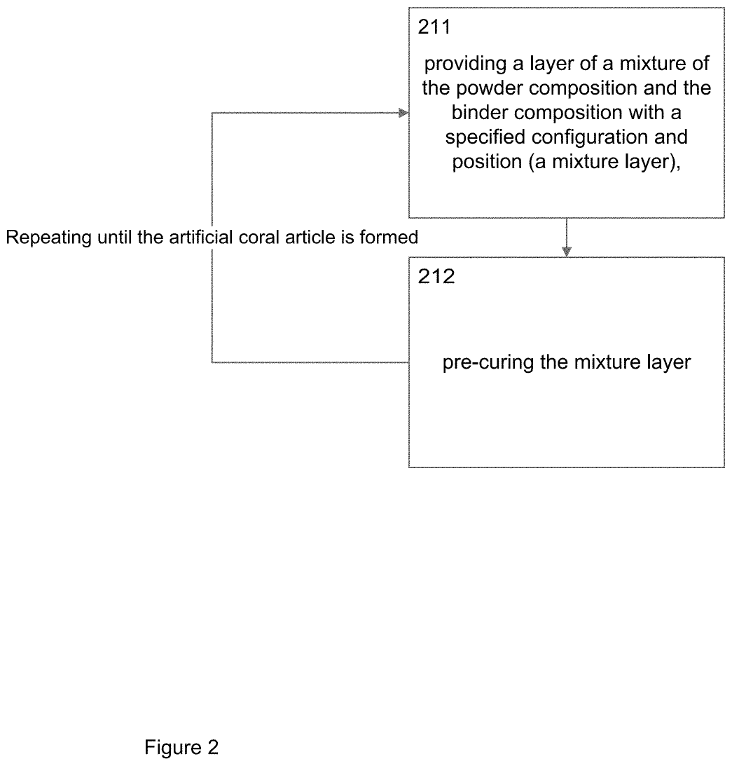

In certain embodiments, the printing step comprises:
a) providing a layer of a mixture of the powder composition and the binder composition with a specified configuration and position (a mixture layer) (Operation 211, FIG. 2), and optionally applying a pressure to the mixture layer to provide a flat and/or even mixture layer;
b) pre-curing the mixture layer of step a) (Operation 212, FIG. 2); and
c) repeating steps a) and b) until the artificial coral article is formed (FIG. 2). The powder composition and/or the binder composition of each cycle of repeating steps a) and b) may be the same or different.

In certain embodiments, the mixture layer is provided by:
ia) providing a layer of the powder composition (a powder composition layer) that encompass the space where the mixture layer is positioned at, optionally applying a pressure to the powder composition layer to provide a flat and/or even powder composition layer; and
ib) applying the binder composition to the space defined by the position and configuration of the mixture layer to form the mixture layer with the specified configuration and position of step a), optionally applying a pressure to the mixture layer to provide a flat and/or even mixture layer.

In certain embodiments, the layer of mixture of step a) is provided by:
iia) providing a powder composition layer with the specified configuration and position of the mixture layer of step a), optionally applying a pressure to the powder composition layer to provide a flat and/or even powder composition layer; and
iib) applying the binder composition to the powder composition layer of step iia) to form the mixture layer with the specified configuration and position of step a), optionally applying a pressure to the mixture layer to provide a flat and/or even mixture layer.

In certain embodiments, the pressure is applied by a roller bar, wiper, or hopper. In certain embodiments, steps ia) and/or iia) comprise depositing or rolling over the layer of the powder composition using a roller bar, wiper, or hopper.

In certain embodiments, each layer (e.g., the powder composition layer and the mixture layer) may have a thickness of about 0.0762 mm, about 0.1016 mm, about 0.127 mm, about 0.2032 mm, about 0.254 mm, about 1 mm to about 8 mm, or about 2 mm to about 7 mm.

Unless otherwise specified, “pre-curing” a mixture layer as used herein means hardening or toughening the mixture layer so that another layer of a powder composition or a mixture of a powder composition and a binder composition may be applied to the cured mixture layer with a desired configuration.

The greenware prepared as disclosed herein may be post-processed to provide the artificial coral article with enhanced mechanical strength, durability, and/or waterproof suitable for use as a safe and lasting home for coral reef ecosystems. The post-processing step may include applying one or more post processing agents to the greenware. The one or more post processing agents may be applied by the same or different methods selected from the group consisting of brushing, spraying, dipping, and submersion.

Examples of the post-processing agents include, without limitation, polymers (e.g., resins). In certain embodiments, polymers used for post-processing may infiltrate the porous structure of the greenware through capillary action before the polymers set or cure. Polymers with low viscosity are preferred for effective infiltration to the greenware. Since the artificial coral articles may be a new home for coral reef ecosystems, polymers used for pos-processing should also be safe to aquatic and crustaceous lives and should not leach harmful chemicals.

Examples of suitable polymers include, without limitation, epoxy resins, and polyeurothane resins.

In certain embodiments of the preparation methods disclosed herein, using a 3D printer (e.g., Zcorp 310) comprises Steps 1 to 4 as disclosed below.

Step 1: Configuring the 3D Printer with the 3D Model of an Intermediate Article to be Printed

A 3D model is provided for the intermediate article with a desired 3D design and “sliced” into layers for printing, e.g., using a typical 3D slicer tool. Configurations and parameters of each “sliced” layer are provided for the 3D printer to determine a space (area, thickness, location) in which to deposit a powder composition disclosed herein, a binder composition disclosed herein, and/or a mixture thereof. A “sliced” layer may be a Boolean code, meaning a closed (watertight) area is consider “inside” the print area and an open area that is NOT the closed area is considered the “outside” print area.

Step 2: Printing the Intermediate Article Using the 3D Printer

In certain embodiments, a base (e.g., a build plate, a build bed) is provided for the intermediate article to be built on layer by layer. The base may be a flat rigid object that the powder may be deposited on as desired so that when excess powder is removed during excavation, the flat rigid object can be picked up and carry the 3D printed object (which may be too fragile to be picked up by itself). The base may also be referred to as a build plate. The base may also be referred to as a build bed when the base already includes some powder.

Subsequent layer of the powder composition is deposited on a pre-cured mixture layer, and the binder composition is deposited to provide another mixture layer with desired shape. The binding composition activates the powder composition for pre-curing to provide another pre-cured mixture layer before another layer of the powder composition is deposited thereon.

In one example, a thin layer of the powder composition may be rolled flat in a base (e.g., a build plate, a build bed). Depending on the mechanics of the 3D powder printer, the initial layers, in addition to all subsequent layers, may be added and/or evened by a roller bar, wiper, or hopper. For example, a new layer of the powder composition may be deposited or rolled over with a specified layer height. Once the layer of powder is provided, a print head uses and X axis and Y axis to “print” the specified layer as fed to the machine by the “slicer” program in Step 1. The print head may deposit the binder composition to the specified area of each “slice” of the desired intermediate article similar to how a conventional printer prints ink on a piece of paper. After a “sliced” layer is “printed” and pre-cured, a new layer of the powder composition is added and prepared using means previously described. Each layer of the thickness of the layer of the powder composition, as well as saturation or quantity of the binder composition deposited, may be parametrized before the printing begins and/or adjusted accordingly during the printing. Layers of the powder composition deposition in the printing process can range from about 1 mm to about 8 mm in thickness. Thickness of each layer may be chosen by the user based upon the configuration and properties of the powder composition and binder composition (e.g., how the chosen powder composition receives the binder composition). A balance may be struck between layer thickness. For example, when a new layer of powder is deposited, the layers adhere to each other and are not dragged away or damaged in the mechanics of the printing process. This process of layer deposition, preparation, and printing are repeated until the desired intermediate article is built up, layer by layer.

Step 3: Excavating the Intermediate Article, and Recycling of the Powder Composition

Once the 3D printer completes the printing process, the 3D printed intermediate article may sit in the base of powder for a time sufficient to dry (e.g., about 3-48 hours, or more, e.g., until sufficient liquid has dried/evaporated from the intermediate article). After the 3D printed intermediate article is excavated from the base of powder. In certain embodiments, the excavating may be accomplished by using brushes and/or air compressed guns to remove uncured powder composition (i.e., the unused powder composition). This unused powder composition may be recycled and used again. The excavated intermediate article is now considered a “greenware,” which means that it is strong enough to hold its shape independently but can still be broken and has not been post-processed. This may be similar to ceramics wherein a clay article is called “greenware” after it is dried but before it is fired and turned into its final hard ceramic form.

Step 4: Post-Processing

The greenware prepared as disclosed herein may be further post-processed to provide the artificial coral article with enhanced mechanical strength, durability, and waterproof suitable for use as a safe and lasting home for coral reef ecosystems. The post-processing step may include applying one or more post processing agents to the greenware. The one or more post processing agents may be applied by brushing, spraying, dipping, and/or submersion. Examples of the post-processing agents include, without limitation, polymers as described herein.

In certain embodiments, the printing method further comprises steps α and step β as described below.

Step α: Loading the Powder Composition into the 3D Printer

A thoroughly mixed powder composition is added into the base (e.g., a build plate, a build bed) of the 3D printer. The powder composition may be “fluffed” due to the mixing process. A pressure may be applied (e.g., by compression of a flat plate) to the powder composition as loaded to provide a compact load of the powder composition. The compact load of the powder composition may provide a better mechanical spreading during printing.

Step β: Loading the Binder Composition into the 3D Printer

A binder composition is loaded into the 3D printer. In certain embodiments, the binder composition is a liquid that travels well through the hoses and print head mesh of the 3D printer, as well as is received well by the powder composition for desired pre-cure results.

### IV. Powder Compositions

Another aspect of the disclosed embodiments related to a powder composition comprising a base composition, and an adhesive composition. In certain embodiments, the powder composition further comprises one or more wicking agents, one or more hygroscopic agents, one or more absorbent agents, one or more deflocculants, or a mixture thereof.

The powder composition disclosed herein can be used for preparation of the artificial coral articles as disclosed herein.

The powder composition has particle sizes of between 200-60 mesh size, about 37-250 microns; or about 60 microns or about 230 mesh size; and has a desired spreadability.

In certain embodiments, a powder composition comprises about 2 to about 5 parts of a base composition, about 1 to about 3 parts of an adhesive composition, and about 0 to about 3 parts of other additives, and all parts are by weight.

A) Base Composition

The base composition should be insoluble or hardly soluble in water, and is preferred to has a neutral pH and desired mechanical and structural property for the intermediate article and/or the final artificial coral article.

Examples of the base composition include without limitation, a calcium salt with a low water solubility (e.g., calcium carbonate, calcium sulfate, etc.), geopolymers such as a ceramic composition (e.g., a phosphate ceramic such as magnesium phosphate ceramic); a plaster; and mixtures thereof. A base composition may stick or bind when activated by the binder composition.

In certain embodiments, the magnesium phosphate ceramic may be prepared by reacting magnesium oxide in an aqueous solution of a phosphate. Examples of phosphates include, without limitation, ammonium phosphate, monoammonium phosphate, potassium phosphate, and monopotassium phosphate.

The magnesium phosphate ceramic has a desired hard cementitious like quality and is largely pH neutral. It is advantageous compared to a concrete because concrete is basic and leaching. Examples of magnesium phosphate ceramic includes, without limitation, Ceramicrete, Grancrete, Gigacrete, AirKrete, and mixtures thereof.

Similarly, a plaster also has the desired neutral pH and cementitious like property, thus may be used as a filler to augment mass and quantity of the mixture.

B) Adhesive Composition

An adhesive composition comprises one or more adhesive agents.

A suitable adhesive agent sticks or binds when activated by the binder composition. The adhesive agent helps to create overall strength of the intermediate article and the artificial coral article, as well as helps in layer adhesion for subsequent layers during the preparation process. Examples of adhesive agents include, without limitation, sugar (e.g., powdered sugar), cellulose and derivatives thereof (e.g., methyl cellulose, carboxy celluloses such as carboxy methyl cellulose (CMC), salts of carboxy cellulose (e.g., sodium carboxy methyl cellulose (Na CMC)), hydroxyethyl cellulose), modified starch (e.g., modified starch ether), wheat paste, polymer (e.g., polyvinal alcohol (PVA) powder), gum Arabic, and mixtures thereof.

For example, sugar may be used as an adhesive agent for its binding characteristics. Sugar may provide strong structural characteristics after wetted with the binder composition and dried. Sugar may also act as a hygroscopic agent.

In certain embodiments, one or more adhesive agents may be a mixture of a powdered sugar can and a starch additive to further improve the wicking ability and flow rate when spreaded.

Cellulose derivatives may be used as a glue binder and/or a thickening agent. For example, methyl cellulose, CMC and Na CMC may be used as a glue binder. In certain embodiments, the adhesive agents are CMC and/or Na CMC. In certain embodiments, hydroxyethyl cellulose may be used as a thickening agent and bonding material that help shaping of the intermediate article during excavation. In certain embodiments, the amount of CMC used is about 33% (wt.) or less.

Modified starch ether is a polysaccharide that may be used as a thickening agent to improve shaping.

In certain embodiments, one or more adhesive agents are a mixture of one or more modified starch ethers and one or more cellulose derivatives (e.g., methyl cellulose, carboxymethyl cellulose).

A wheat paste may be used as a glue binder.

A polymer suitable as an adhesive agent may be a water soluble polymer such as PVA powder.

C. Other Additives

The powder composition may further include one or more other additives selected from the group consisting of wicking agents, absorbent agents, hygroscopic agents, deflocculants. Examples of additives include, without limitation, agents provided in Table 1.

Wicking agents and hygroscopic agents are optional and may help the mechanical and structural property of the intermediate articles and the artificial coral articles disclosed herein.

One or more wicking agents may lower the surface tension on top of a powder composition layer to improve absorbance of the liquid binder composition into a layer of powder composition. A wicking agent may also help to increase the strength of the intermediate articles.

One or more hygroscopic agents may prevent the liquid binder composition from spreading into unprinted areas.

Deflocculants may improve the flowability and/or spreadability of the powder composition. Powder flowability may be influenced by particle size. The lower the particle size the higher the flowability. Also, deflocculants with small particle size may increase the flowability of the powder composition.

TABLE 1
Examples of other additives for the
powder composition

| | Absor- | Hygro- | | | |
|---|---|---|---|---|---|
| | bent | scopic | Wicking | Defloc- | |
| Additive | agent | agent | agent | culant | Notes |
| Maltodextrin | Yes | Very | | Yes | |
| | | much | | | |
| Corn starch | Yes | Very | | Yes | |
| | | strong | | | |
| Wheat Flour | Yes | Yes | Yes | | |
| Tapioca | Yes | Yes | Yes | Yes | |
| Powder | | | | | |
| Gum Arabic | Some | | | Yes | Some |
| | | | | | adhesive |
| | | | | | properties |

### V. Binder Compositions

Another aspect of the disclosed embodiments related to a binder composition comprising one or more solvents. Optionally, the binder composition further comprises one or more glycols (e.g., sugar), one or more humectants and/or one or more surfactants.

The binder composition is a solution having a viscosity of about 10 to about 12 cps, about 1 to about 10 cps, or about 1.35 cps, and a surface tension of about 45 dynes/cm to about 75 dynes/cm. The viscosity of the binder composition should be sufficiently low to avoid clogging the print head, and sufficiently high to avoid leaching.

In certain embodiments, the one or more solvents are selected from the group consisting of water, alcohols, and mixtures thereof. Alcohols may help shorten the time required to pre-cure a mixture layer because alcohols are more volatile than water and may help the solvents to dry and/or evaporate more quickly.

Water helps hydrate and activate the powder composition for pre-curing, especially the adhesive composition of the powder composition. Optionally, the water used is distilled/filtered. However, water that is not distilled or filtered may damage the 3D printer's feed lines and print head with build-up of minerals and residues in the undistilled/unfiltered.

Alcohols help significantly to prevent oversaturation of water and accelerate evaporation of the binder composition in the mixture layer. An alcohol content should be sufficiently low to allow the powder composition to be saturated by water for proper activation and pre-curing of the mixture layer. However, it the alcohol content is too low, the time to pre-cure/dry may become excessive.

Examples of alcohols include, without limitation, ethanol, isopropyl alcohol, sake, and 100+ proof vodka. In certain embodiments, the binder composition comprises 1:1 water and sake.

A small amount of glycols (e.g., sugar) in the binder composition may be beneficial to adhere the mixture layers together. This component of the binder composition especially helps increase layer adhesion between a mixture layer and a powder composition layer. The “stickiness” allows the next powder composition layer to properly adhere to the last pre-cured mixture layer such that all layers are bound into a final object. However, too much glycols (e.g., sugar) content in the binder composition may clog the 3D printer and/or stick part of the mixture layer or powder composition layer to a tool used to even the mixture layer (e.g., roller bar, wiper, or hopper). Too much glycols (e.g., sugar) that is not properly dissolved in the binder composition may become too viscose and clog the 3D printer's hoses and the fine mesh used to dispense the binder composition. An excessive amount of glycols (e.g., sugar) may increase friction as well. Increase in friction or clogging of the 3D printer's print head may cause errors in the printing and overheat of the print head.

One or more humectants may be used to hydrate the powder composition and helps to draw the one or more solvents into the powder composition layer to form a relatively even mixture layer of the powder composition and the binder composition.

One or more surfactants are used to lower the liquids surface tension of the binder composition to improve the mixing of the powder composition and the binder composition. The one or more surfactants may also help the liquid binder travel through the print head's mesh to reduce friction in the print head. Otherwise, the print head may be overheated or clogged by the residues of the binder composition. Additionally, surfactants may decrease the surface tension between a component of a 3d printer (e.g., a roller bar, e.g., a spinning bar) that pulls the powder composition to create a smooth and even layer of powder composition on top of the previous pre-cured mixture layer.

Examples of surfactants include, without limitation, surfynol (acetylene glycol), sodium laurel sulfate, and polysorbate.

Examples of binder compositions are provided in Examples 3 and 4.

### VI. Method for Screening Suitable Material Composition

Another aspect of the disclosed embodiments related to testing various powder composition. In certain embodiments, the method includes steps 1 to 2.

### Step 1: Powder Testing

Before powder selection begins, one can test various mixtures to which powder composition works best.

In certain embodiments, the tests can be conducted by mixing a small batch of a powder composition (between 1 Teaspoon and 1 Cup) and then laying each composition on a flat, non pourus surface (Plastics, Acrylic, glass, etc.). Each composition is then spread or compress to be thin (˜ 1/16″-½″) and flat. The tested composition is then sprayed with a mist, to simulate that of a print head used in the 3D printer, in order to visibly examine who the tested composition both receives powder and dries to harden. An ideal composition is one which receives powder and hydrates well, but does not bead or let the liquid pool on top. An ideal composition also creates a thick/hard film or layer on top. An ideal composition dries within less than 24 hours and is hard/strong enough to pick up and hold itself against gravity.

### Step 2: Powder Mixing

Once an optimal powder composition is selected, the powder must be mixed in their appropriate mixtures with ratios by weight. The powder is to be mixed thoroughly. This means that all powder must be sifted to remove clumps. All clumps that are do not sift out are removed to avoid adding hard cemented material or moisture brought in from mixed powders. Powders are then thoroughly mixed well together to create a homogenous looking mixture. Mixture is best done by mechanical means (mixing apparatus, drill with mixing bit, etc.). Once the powder is thoroughly sifted and mixed, it is ready for printing.

### EXAMPLES

### Example 1: Examples of Powder Compositions

TABLE 2
Components of examples of powder
compositions

| | | | Wicking/ |
|---|---|---|---|
| | Base | Adhesive | Hygroscopic |
| Mix | composition | agents | agents |
| 1 | 3-4 Parts* | 3 Parts | 2-1.5 Parts |
| 2 | 3-4 Parts | 3 Parts | 1-0 Parts |
| 3 | 3 Parts | 2 Parts | 2 Parts |
| 4 | 3 Parts | 2 Parts | 1 Parts |
| 5 | 3 Parts | 2 Parts | 0 Parts |
| 6 | 3 Parts | 1 Parts | 1 Parts |
| 7 | 3 Parts | 1 Parts | 0 Parts |
| 8 | 2 Parts | 1.5 Parts | 1 Parts |
| 9 | 2 Parts | 1 Parts | 1 Parts |
| 10 | 2 Parts | 1 Parts | 0 Parts |
| 11 | 3 Parts | 3 Parts | 3 Parts |

*: All parts are by weight and are within the range of ±0.5 parts.

### Example 2: Example of Compositions Disclosed Herein Using Calcium Carbonate as the Base Composition

Powder compositions disclosed in Example 2 were tested with a binder composition consisting of 3 parts (v.) of water, 6 parts (v.) of sake, 0.85 parts (v.) of propylene glycol and 0.15 parts (v.) of surfynol, (i.e., Binder composition No. 3 as shown in Table 4C of Example 3)

Powder composition No. B prepared a greenware with strength less than that prepared using a powder composition of No. C.

Powder composition No. C provided the best greenware among the compositions tested in this example.

PVA powder worked well in place of CMC as adhesive, and in combination of sugar. PVA showed as a better adhesive (in powder composition No. E) than sugar (powder composition NO. D). However, PVA is more expensive than sugar.

Magnesium ceramic prepared by MgO and phosphate was used as a base composition and an adhesive agent (Powder composition G), and provided greenware more durable and water resistant than those prepared by powder compositions without magnesium ceramic component (e.g., powder compositions A, G, and C). However, magnesium ceramic was more costly and more complicated to make.

Uses of plaster as a filler for the base composition (e.g., powder composition No. A) brought the cost down but was not as desired for polyps growth.

Powder composition No. B had weaker strength, as use of wheat paste did not produce very good strength for the intermediate article.

The most preferred powder composition in this example was powder composition No. C.

TABLE 3A
Powder composition No. A

| | | Parts | |
|---|---|---|---|
| | | (per | Percen- |
| Category | Compound | weight) | tage |
| Base | Calcium | 3 | 33.33% |
| composition | Carbonate | | |
| Base | Plaster | 2 | 22.22% |
| composition | | | |
| Adhesive | CMC | 2 | 22.22% |
| agents | | | |
| Adhesive/ | Sugar | 2 | 22.22% |
| wicking/ | | | |
| hygroscopic | | | |
| agent | Total | 9 | |

TABLE 3B
Powder composition No. B

| | | Parts | |
|---|---|---|---|
| | | (per | Percen- |
| Category | Compound | weight) | tage |
| Base composition | Calcium | 3 | 42.86% |
| | Carbonate | | |
| Adhesive agents | CMC | 1.25 | 17.86% |
| Adhesive agent | Wheat | 1.25 | 17.86% |
| | paste | | |
| Adhesive/ | Sugar | 0.75 | 10.71% |
| wicking/ | | | |
| hygroscopic | | | |
| agent | | | |
| Absorbent/ | Malto- | 0.75 | 10.71% |
| hygroscopic/ | dextrin | | |
| deflocculant | | | |
| | Total | 7 | |

TABLE 3C
Powder composition No. C

| | | Parts | |
|---|---|---|---|
| | | (per | Percen- |
| Category | Compound | weight) | tage |
| Base composition | Calcium | 3 | 50.00% |
| | Carbonate | | |
| Adhesive agent | CMC | 1 | 16.67% |
| Adhesive/ | Sugar | 2 | 33.33% |
| wicking/hygroscopic | | | |
| agents | | | |
| Absorbent/ | Malto- | 2 | 33.33% |
| hygroscopic/ | dextrin | | |
| deflocculant | | | |
| | Total | 8 | |

TABLE 3D
Powder composition No. D

| | | Parts | |
|---|---|---|---|
| | | (per | |
| Category | Compound | weight) | % |
| Base | Calcium | 3 | 42.86% |
| composition | Carbonate | | |
| Adhesive/ | Sugar | 2 | 28.57% |
| wicking/ | | | |
| hygroscopic | | | |
| agent | | | |
| Absrobent/ | Maltodextrin | 2 | 28.57% |
| hygroscopic/ | | | |
| deflocculant | | | |
| | Total | 6 | |

TABLE 3E
Powder composition No. E

| | | Parts | |
|---|---|---|---|
| | | (per | |
| Category | Compound | weight) | % |
| Base | Calcium | 3 | 37.50% |
| composition | Carbonate | | |
| Adhesive | PVA | 1 | 12.50% |
| agents | Powder | | |
| Adhesive/ | Sugar | 2 | 25.00% |
| wicking/ | | | |
| hygroscopic | | | |
| agent | | | |
| Absorbent/ | Maltodextrin | 2 | 25.00% |
| hygroscopic/ | | | |
| deflocculant | | | |
| | Total | 8 | |

TABLE 3F
Powder composition No. F*

| | | Parts | |
|---|---|---|---|
| | | (per | |
| Category | Compound | weight) | % |
| Base | Calcium | 3 | 33.33% |
| composition | Carbonate | | |
| Adhesive | PVA | 1 | 11.11% |
| agent | Powder | | |
| Adhesive | CMC | 1 | 11.11% |
| agent | | | |
| Adhesive/ | Sugar | 2 | 22.22% |
| wicking/ | | | |
| hygroscopic | | | |
| agent | | | |
| Absorbent/ | Maltodextrin | 2 | 22.22% |
| hygroscopic/ | | | |
| deflocculant | | | |
| | Total | 9 | |

*Better than powder composition Nos. D and E.

TABLE 3G
Powder composition No. G

| | | Parts | |
|---|---|---|---|
| | | (per | |
| Category | Compound | weight) | |
| Base | Calcium | 2.25 | 30.20% |
| composition | Carbonate | | |
| Base | Magnesium | 1.5 | 20.13% |
| composition/ | Oxide** | | |
| adhesive | | | |
| agent | | | |
| Base | Monoammonium | 1.2 | 16.11% |
| composition/ | Phosphate | | |
| adhesive | | | |
| agent | | 1.25 | 16.78% |
| Adhesive/ | Sugar | | |
| wicking/ | | | |
| hygroscopic | | | |
| agent | | 1.25 | 16.78% |
| Absorbent/ | Maltodextrin | | |
| hygroscopic/ | | | |
| deflocculant | | | |
| | Total | 7.45 | |

**: The weight ratio of MgO:Phosphate is 1:0.8, i.e.,

### Example 3. Examples of Binder Compositions

Four binder compositions were prepared and tested with a powder composition consisting of 3 parts (wt.) calcium carbonate, 2 parts (wt.) plaster, 2 parts (wt.) sugar, 2 parts (wt.) maltodextring, and 1 part (wt.) carboxymethyl cellulose (Powder composition No. C). Binder compositions comprising sake (Nos. 1 and 3) showed more reliable results than a binder composition comprising vodka (NO. 2). A binder composition comprising propylene glycol, surfynol and sake (No. 3) worked better than a binder composition comprising propylene glycol and sake (No. 1). Surfynol helped reducing the viscosity of the binder composition, which in turn reduced friction, heat generation, and damage to the print head. A binder composition comprising an alcohol (No. 3) worked better than a binder composition without an alcohol (No. 4), although both binder compositions had propylene glycol and surfynol. Alcohol may help reduce drag on the print and drying time needed. However, a higher ratio of alcohol and water may result in less strength overall in the greenware. Sake worked well as alcohol content as it allowed quicker drying time and better layer adhesion overall.

TABLE 4A
Binder Composition No. 1

| | Parts (Volume) | Percentage |
|---|---|---|
| Water | 3 | 30.00% |
| Sake | 6 | 60.00% |
| Propylene glycol | 1 | 10.00% |
| Totals | 10 | |

TABLE 4B
Binder Composition No. 2

| | Parts (Volume) | Percentage |
|---|---|---|
| Water | 2 | 66.67% |
| Vodka | 1 | 33.33% |
| Total | 3 | |

TABLE 4C
Binder Composition No. 3

| | Parts (Volume) | Percentage |
|---|---|---|
| Water | 3 | 30.00% |
| Sake | 6 | 60.00% |
| Propylene glycol | 0.85 | 8.50% |
| Surfynol | 0.15 | 1.50% |
| Totals | 10 | |

TABLE 4D
Binder Composition No. 4

| | Parts (Volume) | Percentage |
|---|---|---|
| Water | 9 | 90.00% |
| Propylene glycol | 0.85 | 8.50% |
| Surfynol | 0.15 | 1.50% |
| Totals | 10 | |

### Example 4. Examples of Binder Compositions Comprising Sake, Propylene Glycol and/or Surfynol

Binder composition Nos. provided in Table 4E below were tested with a powder composition consisting of 3 parts (wt.) calcium carbonate, 2 parts (wt.) plaster, 2 parts (wt.) sugar, 2 parts (wt.) maltodextrin, and 1 part (wt.) CMC.

TABLE 4E:
Binder Composition Nos. I-XII and Test Results

| Binder | | | | | | | | | | | | |
|---|---|---|---|---|---|---|---|---|---|---|---|---|
| No. | I | II | III | IV | V | VI | VII | VIII | IX | X | XI | XII |
| Water | 30 | 30 | 30 | 42.5 | 10 | 75 | 50 | 20 | 80 | 100 | 0 | 25 |
| Sake | 60 | 55 | 55 | 42.5 | 75 | 10 | 50 | 80 | 20 | 0 | 100 | 45 |
| Propylene | 10 | 13 | 15 | 15 | 15 | 15 | 0 | 0 | 0 | 0 | 0 | 30 |
| glycol | | | | | | | | | | | | |
| Surfynol | | 2 | 0 | 0 | 0 | 0 | 0 | 0 | 0 | 0 | 0 | 0 |
| | BEST | Works | Works | Works, | Works | Works | Works | Works | Works. | Works, but | Works OK, | Doesn't work, |
| | | Better | better | long | better | better | but | but | Long | worse | better | Too much |
| | | | | drying | than | than | long | worse | drying | than | without | propylene |
| | | | | time | No. IV, | No. IV, | drying | than | time | No. IV., | water | glycol, |
| | | | | | faster | longer | time | No. IV., | | longer | as less | printer |
| | | | | | drying | drying | | longer | | drying, | “wetness” | head mesh |
| | | | | | and | | | drying, | | dragging | | overheats and |
| | | | | | stronger | | | dragging | | layers. | | printer fails. |
| | | | | | | | | layers. | | | | 30% content of |
| | | | | | | | | | | | | sugar additive |
| | | | | | | | | | | | | (glycol/ |
| | | | | | | | | | | | | polyproplyne |
| | | | | | | | | | | | | glycol) |
| | | | | | | | | | | | | tends to clog |
| | | | | | | | | | | | | print head. |

Notes

### Example 5: Examples of Powder Compositions

Various powder compositions were prepared and tested with binder composition No. 3 as shown in Table 4C of Example 3. Each composition was evaluated based on the following parameters:

1) Spread, characterized by 0-100%, which indicates how well a powder composition layer was spread by a roller bar. Poor spreading was shown when one or more pre-cured mixture layers was dragged or disrupted by the roller bar when the roller bar spread a powder composition layer. Lower value (0%) indicated higher level of layer drag which could be caused by poor adhesion of layers and/or too much surface tension of roller bar.

2) Strength, characterized by 0-5, which indicated the strength of the greenware (i.e., the intermediate article). A lower strength would result in a weaker part of the greenware that was likely to break in handling and processing. The intermediate article might immediately crumble upon excavation if the strength was too low.

3) Acceptable, characterized by yes or no, which indicated whether or not the intermediate article prepared was acceptable for post-processing and subsequent use. “Yes” might include minor defects in form but still acceptable for post-processing and subsequent use. “No” means the mixture did not reliably produce an intermediate article suitable for post-processing and subsequent use.

TABLE 5A
Powder composition Test 1A

| | Compound | Part (by weight) | % |
|---|---|---|---|
| | Calcium Carbonate | 3 | 33% |
| | Sugar | 2 | 22% |
| | Maltodextrin | 3 | 33% |
| | CMC | 1 | 11% |
| | Total | 9 | |
| Spread: | 50% | | |
| Strength: | 0 | | |
| Acceptable | No | | |

Notes:
Failed completely. Too much layer drag, not good layer adhesion.

TABLE 5B
Powder composition Test 1B

| | Compound | Part (by weight) | % |
|---|---|---|---|
| | Calcium Carbonate | 3 | 43% |
| | Sugar | 2 | 22% |
| | Maltodextrin | 1 | 11% |
| | CMC | 1 | 11% |
| | Total | 7 | |
| Spread: | 70 | | |
| Strength: | 3 | | |
| Acceptable | Yes | | |

Notes:
Better layer adhesion, still too much drag then desirable compared to Test 1A.

TABLE 5C
Powder composition Test 2A

| | Compound | Part (by weight) | % |
|---|---|---|---|
| | Calcium Carbonate | 3 | 33% |
| | Sugar | 3 | 33% |
| | Maltodextrin | 2 | 22% |
| | CMC | 1 | 11% |
| | Total | 9 | |
| Spread: | 80 | | |
| Strength: | 5 | | |
| Acceptable | Yes | | |

Note:
Good layer adhesion.

TABLE 5D
Powder composition Test 2B

| | Compound | Part (by weight) | % |
|---|---|---|---|
| | Calcium Carbonate | 3 | 33% |
| | Sugar | 3 | 33% |
| | Maltodextrin | 2 | 22% |
| | CMC | 1 | 11% |
| | Total | 9 | |
| Spread: | 80 | | |
| Strength: | 5 | | |
| Acceptable | Yes | | |

Note:
Failed completely. Too much layer drag, not good layer adhesion.

TABLE 5E
Powder composition Test 2.1A

| | Compound | Part (by weight) | % |
|---|---|---|---|
| | Calcium Carbonate | 3 | 38% |
| | Sugar | 3 | 38% |
| | Maltodextrin | 1 | 13% |
| | CMC | 1 | 13% |
| | Total | 8 | |
| Spread: | 85 | | |
| Strength: | 5 | | |
| Acceptable | Yes | | |

Note:
Very strong, good layer adhesion. Still more drag than desirable. Too much sugar in the mixture made it hard to preserve as sugar absorbed moisture from the ambient atmosphere and caused powder to clump. Thus, sifting of fine mesh may be required to remove clumps that accumulated over time.

TABLE 5F
Powder composition Test 2.1B

| | Compound | Part (by weight) | % |
|---|---|---|---|
| | Calcium Carbonate | 3 | 50% |
| | Sugar | 1 | 17% |
| | Maltodextrin | 1 | 17% |
| | CMC | 1 | 17% |
| | Total | 6 | |
| Spread: | 60 | | |
| Strength: | 0 | | |
| Acceptable | No | | |

Note:
Failed completely. Too much drag, final object crumbled upon excavation. Not enough binder in powder.

TABLE 5G
Powder composition Test 3A

| | Compound | Part (by weight) | % |
|---|---|---|---|
| | Calcium Carbonate | 3 | 33% |
| | Sugar | 2 | 22% |
| | Maltodextrin | 2 | 22% |
| | CMC | 2 | 22% |
| | Total | 9 | |
| Spread: | 90 | | |
| Strength: | 5 | | |
| Acceptable | Yes | | |

Note:
Very Strong. Addition of extra CMC can cause some specific failures: expansion of or distortion of object with addition of liquid binder (over time) causing drag by roller bar.

TABLE 5H
Powder composition Test 3B

| | Compound | Part (by weight) | % |
|---|---|---|---|
| | Calcium Carbonate | 3 | 43% |
| | Sugar | 2 | 29% |
| | Maltodextrin | 2 | 29% |
| | CMC | 0 | 0% |
| | Total | 7 | |
| Spread: | 90 | | |
| Strength: | 4 | | |
| Acceptable | Yes | | |

Note:
Works, but stronger with use of CMC. Somewhat less stable and marginally more drag without CMC compared to Test 3A.

TABLE 5I
Powder composition Test 4

| | Compound | Part (by weight) | % |
|---|---|---|---|
| | Calcium Carbonate | 3 | 43% |
| | Sugar | 1 | 14% |
| | Maltodextrin | 1 | 14% |
| | CMC | 2 | 29% |
| | Total | 7 | |
| Spread: | 90 | | |
| Strength: | 4 | | |
| Acceptable | Yes | | |

Note:
Works, but not as good layer adhesion without wicking agents compared to Test 3A and 3B which had more wicking agents than Test 4.

### Example 5: Powder Compositions Tests with Various Base Compositions

Additional powder compositions were tested with binder composition No. 1 disclosed in Example 3, which consists of 30 parts (v.) of water, 60 parts (v.) of sake and 10 parts (v.) of propylene glycol.

Addition of plaster worked well and did not impact outcome very much as long as plaster was no more than calcium carbonate. In some embodiments plaster helped strengthen or stabilize the intermediate article.

PVA worked well and acted as a strong binder for this application. However, it could be very expensive with relation to the cost of other adhesive materials.

TABLE 6A
Powder compositions test A1-1A

| | Compound | Part (by weight) | % |
|---|---|---|---|
| | Calcium Carbonate | 3 | 30% |
| | Plaster | 1 | 10% |
| | Sugar | 2 | 20% |
| | Maltodextrin | 3 | 30% |
| | CMC | 1 | 10% |
| | Total | 10 | |
| Spread: | 40 | | |
| Strength: | 0 | | |
| Acceptable | No | | |

Notes:
Failed completely. Too much layer drag led to destruction of part during printing process.

TABLE 6B
Powder compositions test A1-1B

| | Compound | Part (by weight) | % |
|---|---|---|---|
| | Calcium Carbonate | 3 | 33% |
| | Plaster | 2 | 22% |
| | Sugar | 2 | 20% |
| | Maltodextrin | 1 | 10% |
| | CMC | 1 | 10% |
| | Total | 9 | |
| Spread: | 75 | | |
| Strength: | 3 | | |
| Acceptable | Yes | | |

Notes:
Better layer adhesion than test A1-1A, still too much drag then desirable.

TABLE 6C
Powder compositions test A1-2A

| | Compound | Part (by weight) | % |
|---|---|---|---|
| | Calcium Carbonate | 3 | 30% |
| | Plaster | 1 | 10% |
| | Sugar | 3 | 30% |
| | Maltodextrin | 2 | 20% |
| | CMC | 1 | 10% |
| | Total | 10 | |
| Spread: | 85 | | |
| Strength: | 5 | | |
| Acceptable | Yes | | |

Notes:
Very strong, good layer adhesion. But there was still more drag than desirable. Too much sugar in the mixture made it hard to preserve as sugar absorbed moisture from the ambient atmosphere and caused powder to clump. Therefore, sifting of fine mesh may be required to remove clumps that accumulated over time.

TABLE 6D
Powder compositions test A1-2B

| | Compound | Part (by weight) | % |
|---|---|---|---|
| | Calcium Carbonate | 3 | 33% |
| | Plaster | 2 | 22% |
| | Sugar | 1 | 11% |
| | Maltodextrin | 2 | 22% |
| | CMC | 1 | 11% |
| | Total | 9 | |
| Spread: | 40 | | |
| Strength: | 0 | | |
| Acceptable | No | | |

Notes:
Failed completely. Too much layer drag, not good layer adhesion.

TABLE 6E
Powder compositions test A1-2.1A

| | Compound | Part (by weight) | % |
|---|---|---|---|
| | Calcium Carbonate | 3 | 33% |
| | Plaster | 1 | 11% |
| | Sugar | 3 | 33% |
| | Maltodextrin | 1 | 11% |
| | CMC | 1 | 11% |
| | Total | 9 | |
| Spread: | 85 | | |
| Strength: | 5 | | |
| Acceptable | Yes | | |

Note:
Very strong, good layer adhesion. Still more drag than desirable. Too much sugar in the mixture made it hard to preserve as sugar absorbed moisture from the ambient atmosphere and caused powder to clump. Thus, sifting of fine mesh may be required to remove clumps that accumulated over time.

TABLE 6F
Powder compositions test A1-2.1B

| | Compound | Part (by weight) | % |
|---|---|---|---|
| | Calcium Carbonate | 3 | 38% |
| | Plaster | 2 | 25% |
| | Sugar | 1 | 13% |
| | Maltodextrin | 1 | 13% |
| | CMC | 1 | 13% |
| | Total | 8 | |
| Spread: | 60 | | |
| Strength: | 0 | | |
| Acceptable | No | | |

Note:
Failed completely. Too much drag, final object crumbled upon excavation. Not enough binder in powder.

TABLE 6G
Powder compositions test A1-3A

| | Compound | Part (by weight) | % |
|---|---|---|---|
| | Calcium Carbonate | 3 | 30% |
| | Plaster | 1 | 10% |
| | Sugar | 2 | 20% |
| | Maltodextrin | 2 | 20% |
| | CMC | 2 | 20% |
| | Total | 10 | |
| Spread: | 90 | | |
| Strength: | 5 | | |
| Acceptable | Yes | | |

Note:
Very Strong. Addition of CMC over 33% caused some specific failures, e.g., expansion of or distortion of object with addition of liquid binder (over time) causing drag by roller bar.

TABLE 6H
Powder compositions test A1-3B

| | Compound | Part (by weight) | % |
|---|---|---|---|
| | Calcium Carbonate | 3 | 33% |
| | Plaster | 2 | 22% |
| | Sugar | 2 | 22% |
| | Maltodextrin | 2 | 22% |
| | CMC | 0 | 0% |
| | Total | 9 | |
| Spread: | 90 | | |
| Strength: | 4 | | |
| Acceptable | Yes | | |

Note:
Worked, but stronger with use of CMC compared to Test A1-3A. Somewhat less stable and marginally more drag without CMC, compared to Test A1-3A.

TABLE 6I
Powder compositions test A1-4A

| | Compound | Part (by weight) | % |
|---|---|---|---|
| | Calcium Carbonate | 3 | 33% |
| | Plaster | 2 | 22% |
| | Sugar | 1 | 11% |
| | Maltodextrin | 1 | 11% |
| | CMC | 2 | 22% |
| | Total | 9 | |
| Spread: | 95 | | |
| Strength: | 5 | | |
| Acceptable | Yes | | |

Note:
Worked, but not as good layer adhesion without wicking agents, compared to Test A1-3A-3B and A2-1A-1B. Plaster required more sugar/malt.

TABLE 6J
Powder compositions test A2-1A

| | Compound | Part (by weight) | % |
|---|---|---|---|
| | Calcium Carbonate | 3 | 33% |
| | Wheat Paste | 2 | 22% |
| | Sugar | 2 | 22% |
| | Maltodextrin | 2 | 22% |
| | CMC | 0 | 0% |
| | Total | 9 | |
| Spread: | 70 | | |
| Strength: | 3 | | |
| Acceptable | Yes | | |

Note:
Weaker compared to a composition without the presence of wheat paste, more prone to distortion from wheat paste. Can lead to failure.

TABLE 6k
Powder compositions test A2-1B

| | Compound | Part (by weight) | % |
|---|---|---|---|
| | Calcium Carbonate | 3 | 38% |
| | Wheat Paste | 1 | 13% |
| | Sugar | 2 | 25% |
| | Maltodextrin | 2 | 25% |
| | CMC | 0 | 0% |
| | Total | 8 | |
| Spread: | 75 | | |
| Strength: | 3 | | |
| Acceptable | Yes | | |

Note:
Weaker compared to a composition without the presence of wheat paste, more prone to distortion from wheat paste. Can lead to failure.

TABLE 6L
Powder compositions test A2-2A

| | Compound | Part (by weight) | % |
|---|---|---|---|
| | Calcium Carbonate | 3 | 38% |
| | Wheat Paste | 2 | 25% |
| | Sugar | 2 | 25% |
| | Maltodextrin | 0 | 0% |
| | CMC | 1 | 13% |
| | Total | 8 | |
| Spread: | 75 | | |
| Strength: | 4 | | |
| Acceptable | Yes | | |

Note:
Weaker compared to a composition without the presence of wheat paste, but stronger with CMC, more prone to distortion from wheat paste. Can lead to failure.

TABLE 6M
Powder compositions test A2-2B

| | Compound | Part (by weight) | % |
|---|---|---|---|
| | Calcium Carbonate | 3 | 38% |
| | Wheat Paste | 2 | 25% |
| | Sugar | 0 | 0% |
| | Maltodextrin | 2 | 25% |
| | CMC | 1 | 13% |
| | Total | 8 | |
| Spread: | 60 | | |
| Strength: | 3 | | |
| Acceptable | No | | |

Note:
Weaker compared to a composition without the presence of wheat paste, more prone to distortion from wheat paste. Can lead to failure. Less layer adhesion with no sugar.

TABLE 6N
Powder compositions test A2-2.1A

| | Compound | Part (by weight) | % |
|---|---|---|---|
| | Calcium Carbonate | 3 | 50% |
| | Wheat Paste | 2 | 33% |
| | Sugar | 0 | 0% |
| | Maltodextrin | 0 | 0% |
| | CMC | 1 | 17% |
| | Total | 6 | |
| Spread: | 40 | | |
| Strength: | 0 | | |
| Acceptable | No | | |

Note:
No enough layer adhesion. Failed.

TABLE 6O
Powder compositions test A3-1A

| | Compound | Part (by weight) | % |
|---|---|---|---|
| | Calcium Carbonate | 3 | 50% |
| | PVA | 1 | 17% |
| | Sugar | 0 | 0% |
| | Maltodextrin | 0 | 0% |
| | CMC | 2 | 33% |
| | Total | 6 | |
| Spread: | 70 | | |
| Strength: | 4 | | |
| Acceptable | Yes | | |

Note:
Poor layer adhesion, could use something to help wick. Intermediate success.

TABLE 6P
Powder compositions test A3-1B

| | Compound | Part (by weight) | % |
|---|---|---|---|
| | Calcium Carbonate | 3 | 38% |
| | PVA | 1 | 13% |
| | Sugar | 2 | 25% |
| | Maltodextrin | 2 | 25% |
| | CMC | 0 | 0% |
| | Total | 8 | |
| Spread: | 95 | | |
| Strength: | 5 | | |
| Acceptable | Yes | | |

Note:
Great strength, worked well.

TABLE 6Q
Powder compositions test A3-2A

| | Compound | Part (by weight) | % |
|---|---|---|---|
| | Calcium Carbonate | 3 | 50% |
| | PVA | 0.5 | 8% |
| | Sugar | 0 | 0% |
| | Maltodextrin | 0 | 0% |
| | CMC | 2 | 33% |
| | Total | 5.5 | |
| Spread: | 50 | | |
| Strength: | 0 | | |
| Acceptable | No | | |

Note:
Failed, not enough layer adhesion. Too much drag.

TABLE 6R
Powder compositions test A3-2B

| | Compound | Part (by weight) | % |
|---|---|---|---|
| | Calcium Carbonate | 3 | 38% |
| | PVA | 0.5 | 6% |
| | Sugar | 2 | 25% |
| | Maltodextrin | 2 | 25% |
| | CMC | 0 | 0% |
| | Total | 7.5 | |
| Spread: | 90 | | |
| Strength: | 5 | | |
| Acceptable | Yes | | |

Note:
Worked well, marginally less strength compared with A3-2A. Not too much noticeable difference.

TABLE 6S
Powder compositions test A3-2.1A

| | Compound | Part (by weight) | % |
|---|---|---|---|
| | Calcium Carbonate | 3 | 50% |
| | PVA | 2 | 33% |
| | Sugar | 0 | 0% |
| | Maltodextrin | 0 | 0% |
| | CMC | 2 | 33% |
| | Total | 7 | |
| Spread: | 60 | | |
| Strength: | 0 | | |
| Acceptable | No | | |

Note:
Intermediate failure, appeared to have insufficient layer adhesion. Successful attempts, although rare, yielded strong pieces.

TABLE 6T
Powder compositions test A3-2.1B

| | Compound | Part (by weight) | % |
|---|---|---|---|
| | Calcium Carbonate | 3 | 38% |
| | PVA | 2 | 25% |
| | Sugar | 2 | 25% |
| | Maltodextrin | 2 | 25% |
| | CMC | 0 | 0% |
| | Total | 9 | |
| Spread: | 100 | | |
| Strength: | 5 | | |
| Acceptable | Yes | | |

Note:
Very strong, use of this much PVA seems excessive.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, modules, systems and compositions.

1. A method for preparing an artificial coral article, comprising:
printing a first intermediate article having a 3D design using a 3D printer with a powder composition and a binder composition;
drying the first intermediate article to provide a greenware of the artificial coral article; and
post-processing the greenware to provide the artificial coral article.

2. The method of claim 1, wherein:
the powder composition comprises a base composition, and an adhesive composition.

3. The method of claim 2, wherein:
the powder composition further comprises one or more wicking agents, one or more hygroscopic agents, one or more absorbent agents, or one or more deflocculants, or a mixture thereof.

4. The method of any one of the preceding claims, wherein:
the binder composition comprises one or more solvents selected from the group consisting of water, alcohols, and mixtures thereof.

5. The method of any one of claims 2-4, wherein:
the base composition comprises one or more agents selected from the group consisting of calcium salts, geopolymers, ceramic compositions, plaster, and mixtures thereof.

6. The method of any one of claims 2-5, wherein:
the adhesive composition comprises one or more agents selected from the group consisting of sugar, cellulose, cellulose derivatives, modified starch, gum Arabic, and mixtures thereof.

7. The method of any one of the preceding claims, wherein:
the powder composition further comprises one or more additives selected from the group consisting of wicking agents, absorbent agents, hygroscopic agents, and deflocculants.

8. The method of any one of the preceding claims, wherein:
the powder composition has particle sizes of between 200-60 mesh size, about 37-250 microns; or about 60 microns or about 230 mesh size.

9. The method of any one of claims 2-8, wherein:
the powder composition comprises about 2 to about 5 parts of the base composition, about 1 to about 3 parts of the adhesive composition, and about 0 to about 3 parts of other additives, and all parts are by weight.

10. The method of any one of the preceding claims, wherein: the amount of CMC is about 33% (wt.) or less.
